(19) United States
(12) Patent Application Publication
(10) Pub. No.: US 2012/0011112 A1
(43) Pub. Date: Jan. 12, 2012

(54) RANKING SPECIALIZATION FOR A SEARCH

(75) Inventors: Jiang Bian, Atlanta, GA (US); Xin Li, San Jose, CA (US); Fan Li, Sunnyvale, CA (US); Zhaohui Zheng, Sunnyvale, CA (US); Hongyuan Zha, Atlanta, GA (US)

(73) Assignee: Yahoo! Inc., Sunnyvale, CA (US)

(21) Appl. No.: 12/831,014

(22) Filed: Jul. 6, 2010

(51) Int. Cl. G06F 17/30

(52) U.S. Cl. 707/723; 707/E17.084

(57) ABSTRACT

Example methods, apparatuses, and articles of manufacture are disclosed that may be used to provide or otherwise support one or more ranking specialization techniques for use with search engine information management systems.

### BACKGROUND

1. Field

The present disclosure relates generally to search engine information management systems and, more particularly, to ranking specialization techniques for use with search engine information management systems.

2. Information

The Internet is widespread. The World Wide Web or simply the Web, provided by the Internet, is growing rapidly, at least in part, from the large amount of information being added regularly. A wide variety of information, such as, for example, web pages, text documents, images, audio files, video files, or the like, is continually being identified, located, retrieved, accumulated, stored, or communicated.

With a large quantity of information being available over the Internet, search engine information management systems continue to evolve or improve. In certain instances, tools or services may be utilized to identify or provide access to information. For example, service providers may employ search engines to enable a user to search the Web using one or more search terms or queries or to try to locate or retrieve information that may be relevant to one or more queries. However, how to rank information in terms of relevance continues to be an area of development.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating an implementation of an example computing environment.

FIG. 2 is a flow diagram illustrating particular features of a process for ranking specialization.

FIG. 3 is a flow diagram illustrating an implementation of a process for ranking specialization.

FIG. 4 is a schematic diagram illustrating an implementation of a computing environment associated with one or more special purpose computing apparatuses.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, and articles of manufacture are disclosed herein that may be used to implement ranking specialization for web searches which may affect ranking relevance of search results, for example, based, at least in part, on differences in search queries. More specifically, as illustrated in example implementations, one or more functions may be trained utilizing one or more machine learning techniques and may be used to establish one or more machine-learned ranking functions. As will be described in greater detail below, machine-learned ranking functions may correspond to various query topics representative of groups or clusters of queries sharing similar characteristics or features for estimating ranking relevance, for example. A loss function associated with multiple ranking functions may be utilized to reduce a statistical ranking risk or loss within one or more groups or clusters by taking into account dependencies between various query topics. A ranking risk may typically, although not necessarily, refer to a statistical risk of error with respect to ranking once a particular classifier(s), such as a particular ranking function(s), for example, is incorporated into a dataset for training, testing, application, etc. For example, an objective of reducing ranking risks may include selecting a classifier such that once incorporated into training, testing, etc. would result in less ranking error than other candidate classifier(s). As will also be seen, a learning approach may use topical probabilities (e.g., of a query belonging to a certain query topic, etc.) to make inferences for a more probable correlation between a query and a query topic such that a ranking loss within one or more groups or clusters with respect to a particular query topic will more likely be associated with a process of learning (e.g., a ranking function, etc.). Based, at least in part, on a correlation between a query and a query topic, a certain number of ranking functions, machine-learned or otherwise, may be selected for use with a search engine information management system at query time, for example.

Before describing some example methods, apparatuses, or articles of manufacture in greater detail, the sections below will first introduce certain aspects of an example computing environment in which information searches may be performed. It should be appreciated, however, that techniques provided herein and claimed subject matter are not limited to these example implementations. For example, techniques provided herein may be adapted for use in a variety of information processing environments, such as database applications, language models processing applications, social networking applications, etc. In addition, any implementations or configurations described herein as “example” are described herein for purposes of illustrations.

The World Wide Web, or simply the Web, comprises a self-sustaining system of computer networks that is accessible to millions of people worldwide and may be considered as an Internet-based service organizing information via use of hypermedia (e.g., embedded references, hyperlinks, etc.). Considering the large amount of information available on the Web, it may be desirable to employ one or more search engine information management systems, which may herein be called simply search engines, to help users to locate or retrieve relevant information, such as, for example, one or more documents of a particular interest. Here, a user or client (e.g., a special purpose computing platform) may submit a search query via an interface, such as a graphical user interface (GUI), for example, by entering certain words or phrases to be queried, and a search engine may return a search results page, which may typically, although not necessarily, include a number of documents listed in a particular order. A “document,” “web document,” or “electronic document,” as the terms used in the context of the present disclosure, are to be interpreted broadly and may include one or more stored signals representing any source code, search results, text, image, audio, video file, or like information associated with the Internet, the World Wide Web, intranets, training datasets, or other like information-gathering or information-processing environments that may be read in some manner by a special purpose computing apparatus and that may be processed, played, or displayed to or by a search engine user. Documents may include one or more embedded references or hyperlinks to images, audio or video files, or other documents. For example, one common type of reference that may be used to identify or locate documents comprises a Uniform Resource Locator (URL). As a way of illustration, documents may include a web page, an e-mail, a Short Message Service (SMS) text message, an Extensible Markup Language (XML) document, a media file, a page pointed to by a URL, just to name a few examples.

In the context of the Web, a user or client may specify or otherwise input one or more search terms (e.g., a query) into a search engine and may receive and view a web page with search results listed in a particular order, as mentioned above. A user or client, via an interface, for example, may access a particular document of interest or relevance by clicking on or otherwise selecting a hyperlink or other selectable tool embedded in or associated with the document. As used herein, “click” or “clicking” may refer to a selection process made by any pointing device, such as, for example, a mouse, track ball, touch screen, keyboard, or any other type of device capable of selecting one or more documents, for example, within a search results web page via a direct or indirect action from a user or client. It should be appreciated, however, that use of such terms is not intended to be limiting. For example, a selection process may be made via a touch screen of a tablet PC, mobile communication device, portable navigation device, etc., wherein “clicking” may comprise “touching.” It should also be noted that these are merely examples relating to selecting documents or inputting information, such as one or more queries, and claimed subject matter is not limited in these respects.

As previously mentioned, it may be desirable to organize potential search results so as to assist a user or client in locating relevant or useful information in an efficient or effective manner. Accordingly, a search engine may employ one or more functions or operations to rank documents estimated to be relevant or useful based, at least in part, on relevance scores, ranking scores, or some other measure of relevance such that more relevant or useful documents are presented or displayed more prominently among a listing of search results (e.g., more likely to be seen by a user or client, more likely to be clicked on, etc.). Typically, although not necessarily, for a given query, a ranking function may determine or calculate a relevance score, ranking score, etc. for one or more documents by measuring or estimating relevance of one or more documents to a query. As used herein, a “relevance score” or “ranking score” may refer to a quantitative or qualitative evaluation of a document based, at least in part, on one or more aspects or features of that document and a relation of such one or more aspects or features to one or more queries. As one example among many possible, a ranking function may calculate one or more aspects of one or more feature vectors associated with particular documents relevant to a query and may determine or calculate a relevance score based, at least in part, thereon. Here, a relevance score may comprise, for example, a sample value (e.g., on a pre-defined scale) calculated or otherwise assigned to a document and may be used, partially, dominantly, or substantially, to rank documents with respect to a query, for example. It should be noted, however, that these are merely illustrative examples relating to relevance scores or ranking scores, and that claimed subject matter is not so limited. Following the above discussion, in processing a query, a search engine may place documents that are deemed to be more likely to be relevant or useful (e.g., with higher relevance scores, ranking scores, etc.) in a higher position or slot on a returned search results page, and documents that are deemed to be less likely to be relevant or useful (e.g., with lower relevance scores, ranking scores, etc.) may be placed in lower positions or slots among search results, as one example. A user or client, thus, may, for example, receive and view a web page or other electronic document that may include a listing of search results presented, for example, in decreasing order of relevance, just to illustrate one possible implementation.

Because queries may vary in terms of semantics, length, popularity, recency, obscurity, etc., a particular ranking function or operation may not be able to adequately address some or all potential query variations, however. For example, queries may be related to or associated with different semantical domains, such as products, travel, cars, or the like, or may be categorized as navigational, informational, transactional, etc. Accordingly, different types of queries may have different feature impacts on ranking relevance, and, as a result, in certain situations, a listing of returned search results may not reflect useful or relevant information, for example. As a way of illustration, a ranking function may present relevant or useful search results in response to relatively short queries (e.g., two, three words, etc.), but may be less likely to provide relevant or useful documents for relatively long queries (e.g., six, seven words, etc.). By way of example, for navigational queries (e.g., for home page finding, etc.), a textual similarity between a query and a title of a document may be a sufficient indicator of ranking relevance. Accordingly, a ranking function or operation useful for navigational queries may not be as useful in terms of results with respect to informational queries, in which term frequency-inverse document frequency (TFIDF) or BM25 features may be better suited for determining relevance. Likewise, for popular queries (e.g., frequent in search logs, etc.), document popularity features (e.g., measured by PageRank, etc.) may be more suitable for determining a relevance score, while for rare or obscure queries these features may be less useful for measuring relevance between a query and a document. Of course, these are merely illustrative examples relating to queries and ranking functions or operations, and claimed subject matter is not limited in this regard.

One possible way to affect ranking relevance of search results may include incorporating different query features (e.g., via training examples, etc.) into a learning process for one or more ranking functions or operations. For example, different ranking functions or operations may be separately trained and used with respect to different types or categories of queries (e.g., pre-defined, etc.) instead of utilizing one or more generalized ranking functions or operations for some or all types of queries. Learning time of such a technique may be relatively long, however, if different ranking functions are to be trained separately. In addition, since a particular ranking function is trained using a part of a training dataset, a fewer number of training examples may be available for training different ranking functions or operations. As such, the lack of training examples may lead to declining accuracy with respect to ranking relevance, for example. Also, pre-defined query categorization may, for example, introduce complexity with respect to grouping or classification into a learning process. Moreover, in these instances, training may not be consistent with application (e.g., may have disjointed functions or algorithms, etc.), for example, due to, at least in part, multiple or different objectives at each operation. For example, a ranking function may be trained separately based, at least in part, on a particular set of training examples and may utilize a particular loss function at training, as previously mentioned. At application, however, relevance scores may be aggregated in some manner utilizing one or more aggregation techniques. As such, here, training and application processes may not be consistent, for example, in terms of focusing on the same or similar ranking risks. Accordingly, it may be desirable to develop one or more methods, systems, or apparatuses by utilizing tailored or specialized ranking functions that reflect different feature impacts of different types of queries. In addition, it may also be desirable to develop one or more methods, systems, or apparatuses that may implement a learning approach to concurrently train ranking functions associated with particular query topics using most or all training examples and facilitate or support combining ranking risks or losses of corresponding query topics at training and application time (e.g., at query). As will also be seen, techniques provided herein may be adapted to effectively or efficiently update ranking functions of corresponding query topics incrementally and, in some situations, independently of other functions so as to affect ranking operations of underperforming query topics without retraining or otherwise significantly negatively impacting other ranking functions.

With this in mind, techniques are presented herein that may account for various features or characteristics of different types of queries in the context of ranking, which may affect quality of search results. More specifically, as illustrated in example implementations, a plurality of ranking-sensitive query topics may be identified based, at least in part, on one or more training queries. As used herein, a ranking-sensitive query topic may represent a group or cluster of queries that may share similar features or characteristics useful or desirable for measuring ranking relevance. For example, different queries of the same topic may have similar characteristics in terms of ranking (e.g., similar family of useful or desirable ranking features) so as to reflect similar feature impacts on ranking scores or otherwise achieve a sufficient ranking relevance with respect to a common ranking function. As will be seen, a loss function, such as, for example, a global loss function may be defined and concurrently introduced into a process for learning a plurality of ranking functions or operations associated with ranking-sensitive query topics to reduce a statistical ranking risk within one or more query topics. In addition, a loss function may be used consistently at training time as well as at query or application time, unlike some of approaches mentioned above, which at times may be disjointed, for example (e.g., at training and application, etc.). A number of ranking functions or operations relevant to a query may be selected and used to rank documents based, at least in part, on a measure of correlation between a query and ranking-sensitive query topics associated with ranking functions or operations. Ranking results may be implemented for use with a search engine or other similar tools responsive to search queries, as will be described in greater detail below.

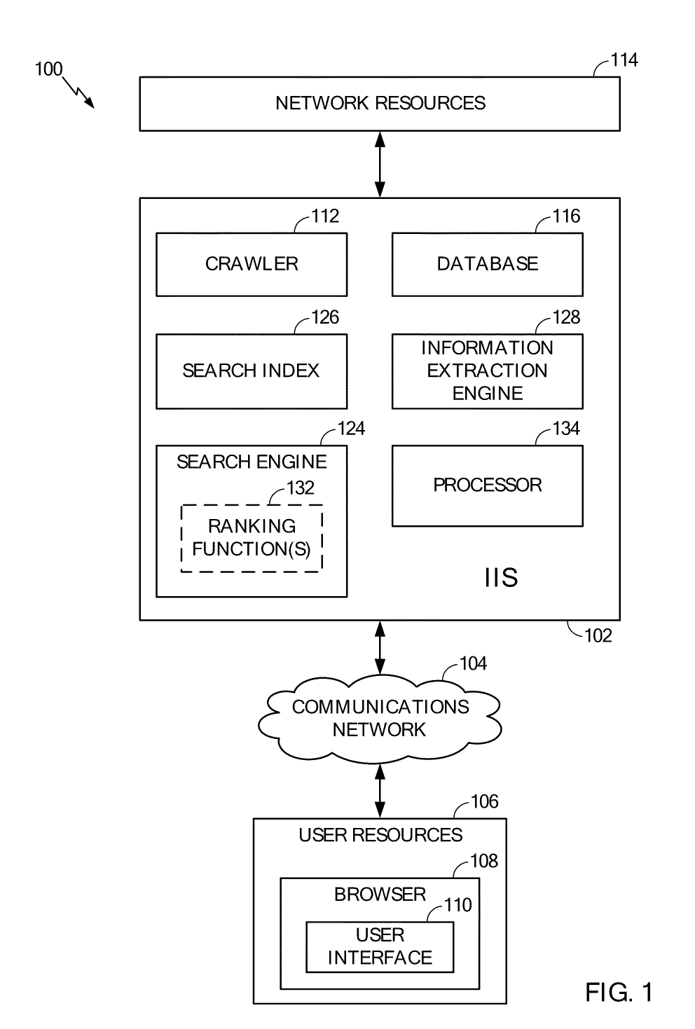

Attention is now drawn to FIG. 1, which is a schematic diagram illustrating certain functional features associated with an example computing environment 100 capable of implementing a ranking specialization for searches, which may affect ranking relevance of search results, for example. Example computing environment 100 may be operatively enabled using one or more special purpose computing apparatuses, information communication devices, information storage devices, computer-readable media, applications or instructions, various electrical or electronic circuitry and components, input information, etc., as described herein with reference to particular example implementations.

As illustrated in the present example, computing environment 100 may include an Information Integration System (IIS) 102 that may be operatively coupled to a communications network 104 that a user or client may employ in order to communicate with IIS 102 by utilizing resources 106. It should be appreciated that IIS 102 may be implemented in the context of one or more search engine information management systems associated with public networks (e.g., the Internet, the World Wide Web) private networks (e.g., intranets), for public or private search engines, Real Simple Syndication (RSS) or Atom Syndication (Atom)-based applications, etc., just to name a few examples.

Here, for example, resources 106 may comprise any kind of computing device, mobile device, etc. communicating or otherwise having access to the Internet over a wired or wireless access point. Resources 106 may include a browser 108 and an interface 110 (e.g., a GUI, etc.) that may initiate transmission of one or more electrical digital signals representing a query. Browser 108 may be capable of facilitating or supporting a viewing of documents over the Internet, for example, such as one or more HTML web pages or pages formatted for mobile communication devices (e.g., WML, XHTML Mobile Profile, WAP 2.0, C-HTML, etc.). Interface 110 may comprise any suitable input device (e.g., keyboard, mouse, touch screen, digitizing stylus, etc.) and output device (e.g., display, speakers, etc.) for user or client interaction with resources 106. Even though a certain number of resources 106 are illustrated in FIG. 1, it should be appreciated that any number of resources may be operatively coupled to IIS 102, such as, for example, via communications network 104.

In this example, IIS 102 may employ a crawler 112 to access network resources 114 that may include, for example, any organized collection of information accessible via the Internet, the Web, one or more servers, etc. or associated with one or more intranets (e.g., documents, sites, pages, databases, discussion forums or blogs, query logs, audio, video, image, or text files, etc.). Crawler 112 may follow one or more hyperlinks associated with electronic documents and may store all or part of electronic documents in a database 116, for example. Web crawlers are known and need not be described here in greater detail.

IIS 102 may further include a search engine 124 supported by a search index 126 and operatively enabled to search for information associated with network resources 114. For example, search engine 124 may communicate with interface 110 and may retrieve and display a listing of search results associated with search index 126 in response to one or more digital signals representing a query. In an implementation, information associated with search index 126 may be generated by an information extraction engine 128, for example, based, at least in part, on extracted content of a file, such as an XTML file associated with a particular document during a crawl. Of course, this is merely one possible example, and claimed subject matter is not so limited.

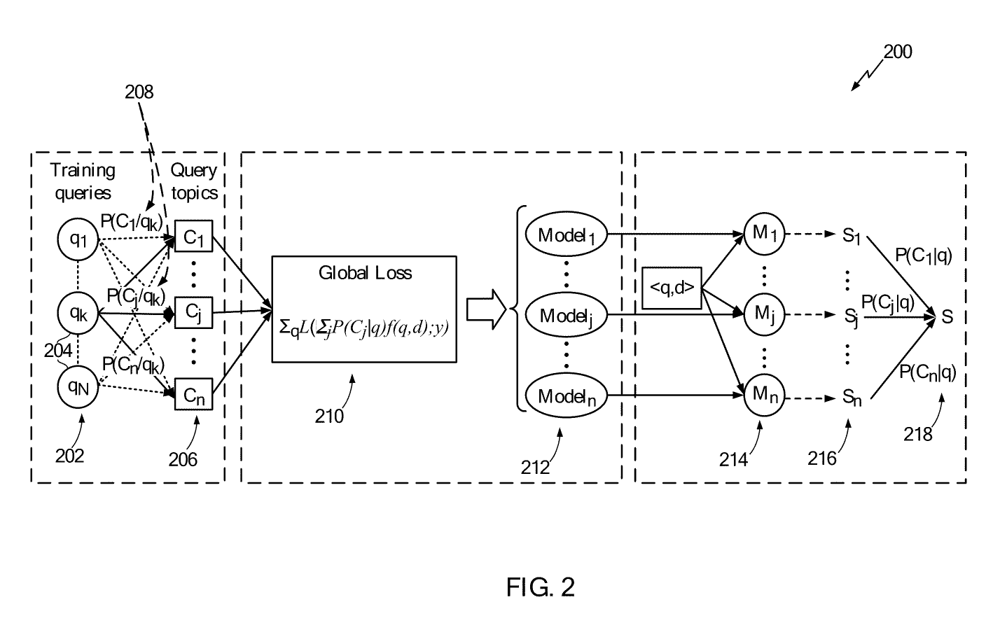

As previously mentioned, search engine 124 may determine whether a particular query relates to one or more documents and may retrieve and display (e.g., via interface 110) a listing of search results in a particular order in response to a query. Accordingly, search engine 124 may employ one or more ranking functions, indicated generally in dashed lines at 132, to rank search results in an order that may be based, at least in part, on a relevance to a query. For example, ranking function(s) 132 may determine relevance scores for one or more documents based, at least in part, on a measure of correlation between a query and ranking-sensitive query topics associated with one or more ranking functions or operations, as will be described in greater detail below with reference to FIG. 2. In addition, ranking function(s) 132 may be capable of aggregating relevance scores to arrive at adjusted ranking scores according to one or more techniques associated with ranking specialization, as will also be seen. It should be noted that ranking function(s) 132 may be included, partially, dominantly, or substantially, in search engine 124 or, optionally or alternatively, may be operatively coupled to it. As illustrated, IIS 102 may further include a processor 134 that may be operatively enabled to execute special purpose computer-readable instructions or implement various modules, for example.

In operative use, a user or client may access a search engine website, such as www.yahoo.com, for example, and may submit or input a query by utilizing resources 106. Browser 108 may initiate communication of one or more electrical digital signals representing a query from resources 106 to IIS 102 via communication network 104. IIS 102 may look up search index 126 and establish a listing of documents based, at least in part, on relevance scores determined or aggregated, partially, dominantly, or substantially according to ranking function(s) 132. IIS 102 may then communicate a listing of ranked search results to resources 106 for displaying on interface 110.

FIG. 2 is a schematic illustrating features of an example process or approach 200 for performing one or more ranking specialization techniques that may be implemented, partially, dominantly, or substantially, in the context of a search, on-line or off-line simulations, modeling, testing, training, ranking, querying, or the like. It should be noted that information applied or produced, such as results associated with example process 200 may be represented by one or more digital signals. Process 200 may begin at operation 202 with generating a set of query features to represent one or more queries q (e.g., query representations) based, at least in part, on one or more pseudo-feedbacks received in response to one or more training queries, indicated generally at 204. For purposes of explanation, a “pseudo-feedback” may refer to a process or technique that may be used, for example, to affect ranking relevance. For example, a number of documents may be retrieved using one or more suitable ranking functions, and a certain number of top-ranked documents may be assumed to be relevant. A training query may be formulated based, at least in part, on one or more query terms associated with these top-ranked documents, for example, for another round of retrieval. As such, some relevant documents missed in an initial round may then be found or retrieved to affect ranking relevance. Techniques or processes associated with pseudo-feedbacks are known and need not be described here with greater particularity.

For example, for a given training query qε [symbol] ₜᵣₐᵢₙ, a set of pseudo-feedbacks D(q)={d₁, d₂, . . . , d_{T}} ranked by a suitable baseline or reference function or operation may be retrieved. A set of pseudo-feedbacks may comprise a certain number of documents representing top T results (e.g., top 20, 50, 100, etc.), for example, where T comprises a sample value. It should be noted that the number of documents received in response to a particular training query may be less than T, in which case all documents received in response to that training query may be utilized. By way of example but not limitation, one or more known information retrieval functions, such as, for example, BM25 may be used as a choice to serve as a baseline function or operation for one or more sets of pseudo-feedbacks, though claimed subject matter is not so limited. It should be appreciated that any suitable baseline function or operation or any combination of suitable baseline functions or operations may be used to generate one or more query features associated with example process 200. As a way of illustration, an enhanced BM25 function or operation, BM25F function or operation, TF-IDF function or operation, or other like or different retrieval functions or operations, separately or in combination, based, at least in part, on term frequency, inverse document frequency, etc., or any other feature (e.g., a unit of information, etc.) of a candidate document may also be utilized. These information retrieval functions or operations are known and need not be described here in greater detail. Of course, claimed subject matter is not limited to these particular examples.

Ranking features of a query-document pair [symbol] q, dᵢ [symbol] associated with one or more pseudo-feedbacks may be defined or represented as a feature vector (e.g., multi-dimensional, etc.) x^{qd}^{ᵢ}= [symbol] x₁^{qd}^{ᵢ}, x₂^{qd}^{ᵢ}, . . . , x_{N}^{qd}^{ᵢ} [symbol] , where N comprises a sample value of ranking features. A training query q may be represented in a feature space, for example, by aggregating ranking features of top T (e.g., top 20, 50, 100, etc.) pseudo-feedbacks for q into a feature vector. Some examples of aggregation methods may include a mean and a variance of ranking feature values, though claimed subject matter is not limited in these respects. For example, mean values of ranking features of top T pseudo-feedbacks may be determined as a feature vector of a training query q. In addition, one or more statistical sample quantities, such as, for example, a variance may be added into a query feature vector, as one example among many possible. It should be appreciated that other statistical sample quantities, such as a median, a percentile of mean, a maximum, a sample number of instances, a ratio, a rate, a frequency, etc., or any combination thereof, that may account for various ranking feature sample values, for example, may be utilized to represent expanded query features. Of course, these are merely examples, and claimed subject matter is not so limited.

Here, for example, a feature vector of query q may be represented as:

[symbol]

μ₁(q),μ₂(q), . . . , μ_{N}(q),σ₁²(q),σ₂²(q), . . . , σ_{N}²(q)

[symbol]

where μₖ(q) denotes a mean value of k-th feature over q's pseudo-feedbacks, and σₖ²(q) denotes a variance value of k-th feature over q's pseudo-feedbacks.

In certain implementations, quantile normalization may be applied on ranking features of query-document pairs, for example, to provide for use of one or more linear ranking functions or operations, such as a linear support vector machine (SVM) function or operation with respect to example process 200, as will be seen. For example, a query-document pair may be given or assigned a sample value of a similarity score with respect to one or more ranking features in a scale of [0, 1] (e.g., with 0 representing the smallest value of similarity, and 1 representing the largest value), such that sample values of extracted query features are also scaled as [0, 1]. It should be appreciated that quantile normalization may be implemented separately from operation 202, such as, for example, before generating one or more query features.

After generating one or more query features, at operation 206, one or more clustering methods may be utilized, for example, to establish one or more clusters representative of ranking-sensitive query topics based, at least in part, on one or more machine-learned functions or operations. In an example implementation, a machine-learned function or operation may be established without editorial input or operate in an unsupervised mode. Optionally or alternatively, one or more machine learning applications, tools, etc. (e.g., a learner) may be enabled to establish one or more machine-learned functions or operations based, at least in part, on editorial input (e.g., in a supervised learning mode). As previously mentioned, a ranking-sensitive query topic may represent or comprise a group or cluster of queries that share similar features or characteristics useful or desirable for measuring ranking relevance. By way of example but not limitation, some useful or desirable features may include one or more text-matching features, link-based features, user-click features, query classification features, etc. Of course, these are merely examples of features that may define ranking-sensitive query similarities or share ranking-sensitive properties, and claimed subject matter is not limited in these respects.

In an implementation, the Pearson correlation may be used, partially, dominantly, or substantially, as a distance measure of query feature vectors, for example, so as to establish one or more ranking-sensitive query topics. To illustrate, for training queries qᵢ and qⱼ with corresponding feature vectors xⁱ= [symbol] x₁ⁱ, x₂ⁱ, . . . , x_{N}_{_{q}}ⁱ [symbol] and x^{j}= [symbol] x₁^{j}, x₂^{j}, . . . , x_{N}_{_{q}}^{j} [symbol] , respectively, the Pearson correlation may be computed as:

$$r ( {q}_{i} , {q}_{j} ) = \frac{1}{{N}_{q}} {\sum }_{k = 1}^{{N}_{q}} ( \frac{{x}_{k}^{i} - {\overline{x}}^{i}}{{σ}_{{x}^{i}}} ) ( \frac{{x}_{k}^{j} - {\overline{x}}^{j}}{{σ}_{{x}^{j}}} ) \qquad ( 1 )$$

where N_{q} denotes a number of query features, x̅ⁱ and x̅^{j} are the averages of feature values in xᵢ and xⱼ, respectively, and σₓ_{^{j}} and σₓ_{^{j}} are the standard deviations of feature values xᵢ and xⱼ, respectively.

To account for differing degrees of usefulness or desirability between feature vectors, for example, prior knowledge of usefulness or desirability of ranking features (e.g., ranking-sensitive feature usefulness or desirability) may be incorporated into the Pearson query correlation as a weight vector or weights for computing vector distance. Thus, in this example, having identified feature usefulness or desirability scores (e.g., using ranking weights learned by a general ranking SVM on a sample of training signal data or other like process) as w= [symbol] w₁, w₂, . . . , w_{N}_{_{q}} [symbol] , the weighted Pearson query correlation (e.g., between qᵢ and qⱼ) may be computed as:

$${r}_{weight} ( {q}_{i} , {q}_{j} ) = \frac{1}{{\sum }_{k = 1}^{{N}_{q}} {w}_{k}} {\sum }_{k = 1}^{{N}_{q}} {w}_{k} ( \frac{{x}_{k}^{i} - {\overline{x}}^{i}}{{σ}_{{x}^{i}}} ) ( \frac{{x}_{k}^{j} - {\overline{x}}^{j}}{{σ}_{{x}^{j}}} ) \qquad ( 2 )$$

In this illustrated example, a cluster may be considered as one ranking-sensitive query topic represented in a feature space by using a centroid of a corresponding cluster. A sample value of clusters representative of ranking-sensitive query topics C_{query}={C₁, C₂, . . . , Cₙ} in a dataset may be established empirically as a constant n, for example, or, optionally or alternatively, through a gap statistic (e.g., via comparing a change in within-cluster dispersion with an expectation under any suitable baseline null distribution function or operation, etc.).

By way of example but not limitation, Table 1 shown below illustrates eight useful or desirable query features learned by Topical Ranking SVM (TRSVM) function, which will be described in greater detail below, with respect to three ranking-sensitive query topics. As seen, features used in building ranking functions associated with respective query topics may include, for example, language model-type features (e.g., LMIR), probabilistic features (BM25), link-based features, etc., just to name a few. Of course, it should be appreciated that various ranking functions may include other features useful or desirable for ranking, and claimed subject matter is not limited to the features shown.

TABLE 1
Examples of top 8 important features for TRSVM.

| TRSVM (topic-1) | TRSVM (topic-2) | TRSVM (topic-3) |
|---|---|---|
| sitemap based term propagation | number of slash in URL | length of URL |
| sitemap based score propagation | HostRank | outlink number |
| length of URL | HITS sub | sitemap based term propagation |
| number of slash in URL | sitemap based score propagation | sitemap based score propagation |
| DL or URL | sitemap based term propagation | number of slash in URL |
| weighted in-link | uniform out-link | HITS sub |
| number of child page | Outlink number | DL or URL |
| BM25 of title | LMIR.ABS of URL | DL or title |

With regard to operation 208, as generally indicated in respective dashed lines, statistical probabilities of a query q belonging to one or more established clusters Cᵢ representative of ranking-sensitive query topics may be determined. For example, based, at least in part, on a representation of query topics in feature space, a topic distribution Topic(qᵢ)={P(C₁|q, P(C₂|q), . . . , P(Cₙ|q)} over established or identified ranking-sensitive query topics for query q may be calculated as:

$$P ( {C}_{k} \vert q ) = \frac{r ( {x}^{q} , {x}^{{C}_{k}} )}{{\sum }_{i = 1}^{n} r ( {x}^{q} , {x}^{{C}_{i}} )} \qquad ( 3 )$$

where r(x^{q},x^{C}^{ᵢ}) denotes the Pearson correlation between a training query q and ranking-sensitive query topic Cᵢ in a query feature space. It should be noted that if a weighted Pearson correlation (e.g., Relation 1) is used with respect to establishing one or more clusters representative of ranking-sensitive query topics, then a weighted Pearson correlation r_{weight}(x^{q},x^{C}^{ᵢ}) between q and Cᵢ may be utilized in Relation 3. As shown in this example implementation, this targeted approach may be conceptualized, for example, as dividing a task of learning a ranking function or operation for a number of training queries into a set of sub-tasks of learning a ranking function or operation for a particular ranking-sensitive query topic. Accordingly, by focusing on a ranking function or operation tailored for a particular query topic, ranking specialization may be useful for determining relevance.

At operation 210, having identified or established one or more clusters representative of ranking-sensitive query topics, one or more digital signals representing machine-learned ranking functions or operations may be concurrently trained with respect to these query topics. For example, one or more ranking functions ƒᵢ (i=1, 2, . . . , n) of respective ranking-sensitive query topics C₁, C₂, . . . , Cₙ may be trained based, at least in part, on a unified SVM-based approach by defining and applying a loss function, such as, for example, a global loss function, for example, so as to reduce loss associated with ranking. Typically, although not necessarily, to facilitate or support ranking, a function ƒ in the form of y=ƒ(x,ω), θε [symbol] , for example, may be utilized, where x represents a feature vector of a query-document pair, ω represents unknown parameters, and y denotes ranking scores of x. A task of learning one or more ranking functions includes selecting a suitable function \hat{ƒ}, for example, that may reduce a given loss function, or:

$$\hat{f} = arg {min}_{f ∈ ℱ} {\sum }_{i = 1}^{N} L ( f ( {x}_{i} , ω ) , {y}_{i} ) \qquad ( 4 )$$

where N denotes a sample value of query-document pairs in a training dataset, L denotes a defined loss function.

As illustrated by Relation 4, a ranking approach typically, although not necessarily, learns a ranking function for most or all types of queries. Different queries may have different ranking features or characteristics, however, as previously mentioned, which may impact ranking relevance. For example, effectiveness or efficiency of a ranking relevance may be affected by reducing emphasis on ranking risks (e.g., losses) of different ranking-sensitive query topics and on dependency between different query topics, as was also indicated. To address query variations or differences, an approach of learning multiple ranking functions or operations with respect to a plurality of ranking-sensitive query topics having different ranking features or characteristics may be implemented. As will be seen, in order to consider dependency between different query topics and let training examples associated with a training dataset contribute to different ranking functions or operations, a loss function, such as, for example, a global loss function may be defined and used. A loss function may, for example, combine risks associated with loss within identified query topics (e.g., ranking risks) with different weights reflecting a measure of correlation between a training query and ranking-sensitive query topics. In an implementation, a measure of correlation may comprise, for example, a probability of a particular training query belonging to a particular query topic, though claimed subject matter is not so limited. Here, for example, if a particular training query has a higher correlation with respect to a certain query topic(s), a training example associated with such a training query may contribute more to learn a ranking function or operation associated with this query topic(s), just to illustrate one possible approach. As will also be see, a loss function, such as a global loss function may be applied consistently at training and application or query time, for example, to allow different query topics to contribute to identified ranking functions or operations, and, as such, multiple ranking functions or operations may be learned concurrently or simultaneously, as illustrated at operation 212.

More specifically, in an example implementation, given identified ranking-sensitive query topics C₁, C₂, . . . , Cₙ, a plurality of ranking functions ƒ₁, ƒ₂, . . . , ƒₙε [symbol] representing ranking features of corresponding query topics may be learned via an application of a loss function, such as a global loss function that may, for example, be defined as:

$$〈 {\hat{f}}_{1} , … , {\hat{f}}_{n} 〉 = arg min {\sum }_{i = 1}^{N} L ( {\sum }_{j = 1}^{n} P ( {C}_{j} \vert q ) {f}_{j} ( {x}_{i}^{q} , {ω}_{j} ) , {y}_{i} ) \qquad ( 5 )$$

where xᵢ^{q} denotes that the i-th query-document pair in training sample values corresponding to training query q, n denotes a number of identified ranking-sensitive query topics, P(Cⱼ|q) denotes a statistical probability that q belongs to Cⱼ, and ωⱼ denotes unknown parameters of the ranking function ƒⱼ corresponding to the query topic Cⱼ. As reflected in Relation 5, if training query q is sufficiently correlated to a query topic Cⱼ (e.g., with a statistically sufficient probability P(Cⱼ|q)), ranking loss under q will be more likely associated with learning ωⱼ since q will contribute more to learn a ranking function of this particular query topic, as previously mentioned.

In certain example implementations, one or more techniques or processes may be implemented, for example, to affect ranking relevance of a specialized ranking function or operation while also reducing ranking risks. Some examples may include SVM, Boosting, Neutral Network, etc., just to name a few; although, of course, claimed subject matter is not limited to these particular examples. Here, for example, an example unified SVM-based technique may be employed, in whole or in part, in a unified learning process at operation 210. Thus, by way of example but not limitation, Topical Ranking SVM function or operation is presented herein, which may be utilized to incorporate ranking-sensitive query topics, directly or indirectly, into a ranking process. As such, Topical Ranking SVM may address potential query topic dependencies, for example, by concurrently learning multiple ranking functions for different query topics, as previously mentioned. In addition to addressing potential dependencies between different query topics, Topical Ranking SVM function or operation may reduce depletion of training examples in a training dataset, as was also discussed above.

More specifically, in an implementation, a learning task in Relation 5 may be specified, for example, by defining a particular ranking function and a loss function. By way of example, a ranking function ƒ may be represented as a linear function ƒ(x,ω)=ω^{T}x, and a loss function L (e.g., norm) may be represented as L(ƒ(x,ω),y)=∥ƒ(x,ω)−y∥², though claimed subject matter is not so limited. Here, a Ranking SVM function or operation may be utilized, for example, to serve as a baseline, just to illustrate one possible implementation. Typically, although not necessarily, a learning task with respect to a Ranking SVM function or operation may be defined as a quadratic programming objective, or:

$${min}_{ω , {ξ}_{q , i , j}} \frac{1}{2} {‖ ω ‖}^{2} + c {\sum }_{q , i , j} {ξ}_{q , i , j} \\ s . t . {ω}^{T} {x}_{i}^{q} \geq {ω}^{T} {x}_{j}^{q} + 1 - {ξ}_{q , i , j} , \\ ∀ {x}_{i}^{q} ≻ {x}_{j}^{q} , {ξ}_{q , i , j} \geq 0 \qquad ( 6 )$$

where xᵢ^{q} [symbol] xⱼ^{q} implies that document i is ranked ahead of j with respect to query q in the training dataset, ξ_{q,i,j} is the slack variable, and ∥ω∥² represents structural loss.

Although Ranking SVM may be a useful approach in learning certain ranking functions or operations, it may be advantageous to incorporate some measure of correlation between identified query topics and training queries into a learning process, as previously mentioned. A measure of correlation may comprise, for example, a topical probability representative of a statistical probability of a training query belonging to a particular query topic, as was also discussed. Thus, a topical probability may be incorporated into constraints of an objective function with respect to different query topics taking into account quadratic interactions of Ranking SVM. Accordingly, a quadratic programming objective of Relation 6 may take the form of a Topical Ranking SVM as follows:

$${min}_{ω , {ξ}_{q , i , j}} \frac{1}{2} {\sum }_{k = 1}^{n} {‖ {ω}_{k} ‖}^{2} + c {\sum }_{q , i , j} {ξ}_{q , i , j} \\ s . t . {\sum }_{k = 1}^{n} P ( {C}_{k} \vert q ) {ω}_{k}^{T} {x}_{i}^{q} \geq {\sum }_{k = 1}^{n} P ( {C}_{k} \vert q ) {ω}_{k}^{T} {x}_{j}^{q} + 1 - {ξ}_{q , i , j} , \\ ∀ {x}_{i}^{q} ≻ {x}_{j}^{q} , {ξ}_{q , i , j} \geq 0 \qquad ( 7 )$$

where ωₖ denotes parameters of a ranking function with respect to query topic Cₖ.

As illustrated by an example implementation, while potentially treated differently in learning ranking functions, training queries may concurrently contribute to learn ranking functions or operations of identified query topics at operation 212. By incorporating ranking-sensitive query topics into a ranking process and concurrently learning multiple ranking functions of different query topics, such a unified approach may be conceptualized, for example, as conquering a task of learning a respective ranking function or operation for various query topics.

Upon learning multiple ranking functions or operations corresponding to ranking-sensitive query topics, a process may further execute instructions on a special purpose computing apparatus to conduct ranking at query time. In an implementation, ranking may be conducted, for example, without an editorial input or in an unsupervised mode. It should be appreciated that in other example implementations, one or more machine-learned functions may be capable of recognizing, modifying, or otherwise establishing one or more feature properties, vector space properties, etc., based, at least in part, on editorial input (e.g., in a supervised mode) that may be utilized by or in a ranking function or other like function associated with a search engine.

At operation 214, for a given query, a number of ranking functions or operations may be selected based, at least in part, on a measure of correlation between corresponding (e.g., to the ranking functions or operations) ranking-sensitive query topics and a query. As a way of illustration, a measure of correlation may comprise, for example, a statistical probability of a query belonging to one or more clusters representative of one or more ranking-sensitive query topics, though claimed subject matter is not so limited. For example, a particular query may be sufficiently correlated with a certain ranking-sensitive query topic by having a similar set of useful or desirable features for measuring ranking relevance, as previously mentioned.

With regard to operation 216, a certain number of ranking functions or operations whose corresponding query topics have sufficient degree of correlation with a query (e.g., topical probability) may retrieve and rank a number of documents according to a calculated relevance score by utilizing ranking functions or operations of the selected query topics. As used herein, a “topical probability” may refer to a quantitative evaluation of the likelihood that a particular query (e.g., training query, query, etc.) will belong to a particular cluster representative of a ranking-sensitive query topic. Under some circumstances, a probability may be estimated, at least in part, from a sample value (e.g., on a predefined scale) that may be assigned to or otherwise determined with respect to a particular query in relation to one or more other queries.

Similar queries in a ranking-sensitive feature space may have similar ranking features or characteristics. Accordingly, if a particular query topic has a higher correlation to a query, corresponding ranking functions or operations may contribute more with respect to such a query. Of course, any like process, its variants, or features may also be implemented, partially or substantially, in one or more methods, for example, or may serve as a reproducible baseline for other functions or processes not inconsistent with example process 200.

With this in mind, at operation 218, an adjusted ranking score may be determined, by aggregating relevance scores calculated by selected ranking functions or operations with respect to a document, for example, with weights based, at least in part, on similarity (e.g., topical probability) between a query and ranking-sensitive query topics. Thus, for a given query \tilde{q}, consider that \hat{ƒ}₁, \hat{ƒ}₂, . . . , \hat{ƒ}ₙ represent learned ranking functions or operations corresponding to query topics C₁, C₂, . . . , Cₙ, respectively, {\tilde{d}₁, \tilde{d}₂ . . . , \tilde{d}_{M}_{_{\tilde{q}}}} is the set of documents to rank with respect to \tilde{q}, and P(C₁|\tilde{q}), P(C₂|\tilde{q}), . . . , P(Cₙ|\tilde{q}) represent probabilities that \tilde{q} belongs to query topics. In this example, an adjusted ranking score S(\tilde{q}, \tilde{d}ᵢ) for a document \tilde{d}ᵢ (i=1, . . . , M_{\tilde{q}}) may, for example, be computed as:

$$S ( \tilde{q} , {\tilde{d}}_{i} ) = {\sum }_{k = 1}^{n} P ( {C}_{k} \vert \tilde{q} ) {\hat{f}}_{k} ( {x}^{\tilde{q} {\tilde{d}}_{i}} , {ω}_{k} ) \qquad ( 8 )$$

where x^{\tilde{q}\tilde{d}}^{ᵢ} denotes a ranking feature vector of the query-document pair of \tilde{q} and \tilde{d}ᵢ, and ωₖ denotes parameters of \hat{ƒ}ₖ.

The documents may then be ranked based, at least in part, on their respective adjusted ranking scores and presented in a listing of search results that may be arranged, for example, in decreasing order of relevance in response to a query. As seen, an approach at query or application time is consistent with an approach in training, meaning that a risk of loss is addressed in a similar fashion.

As illustrated in example implementations, ranking specialization techniques presented herein may account for various ranking-sensitive features or characteristics of different types of queries. As seen, ranking specialization techniques may be used to consistently apply the same approach in training and application. More specifically, a loss function, such as, for example, a global loss function may be applied at training time as well as at query time. In addition, by dividing a task of learning into a set of specialized sub-tasks, a dependency between different query topics may be sufficiently addressed, and topical contribution to a loss function may be sufficiently considered. Also, because ranking specialization techniques may employ somewhat broader query grouping (e.g., soft clustering) using topical probabilities, fine-grained or otherwise higher degree of query categorization (e.g., pre-defined, etc.) may not be needed. Further, because Topical Ranking SVM function or operation uses all training examples in a dataset, there is no need to divide training examples to separately train various ranking functions. As such, the lack of training examples and, thus, declining accuracy due to training a function using smaller number of examples may be prevented. As also illustrated, with a specialized ranking function or operation corresponding to a certain query topic, it may be possible to analyze a performance of a particular ranking function or operation separately so as to focus on incrementally improving some ranking functions or operations (e.g., underperforming, etc.) without substantially affecting others. As such, new, obscure, or otherwise underperforming queries may be used to create one or more additional or separate query topics, for example, to be trained separately so as to build, update, or otherwise adjust their corresponding ranking functions or operations without unnecessary modifying ranking functions or operations of performing query topics. Of course, a ranking specialization process and its benefits are provided by way of examples to which claimed subject matter is not limited.

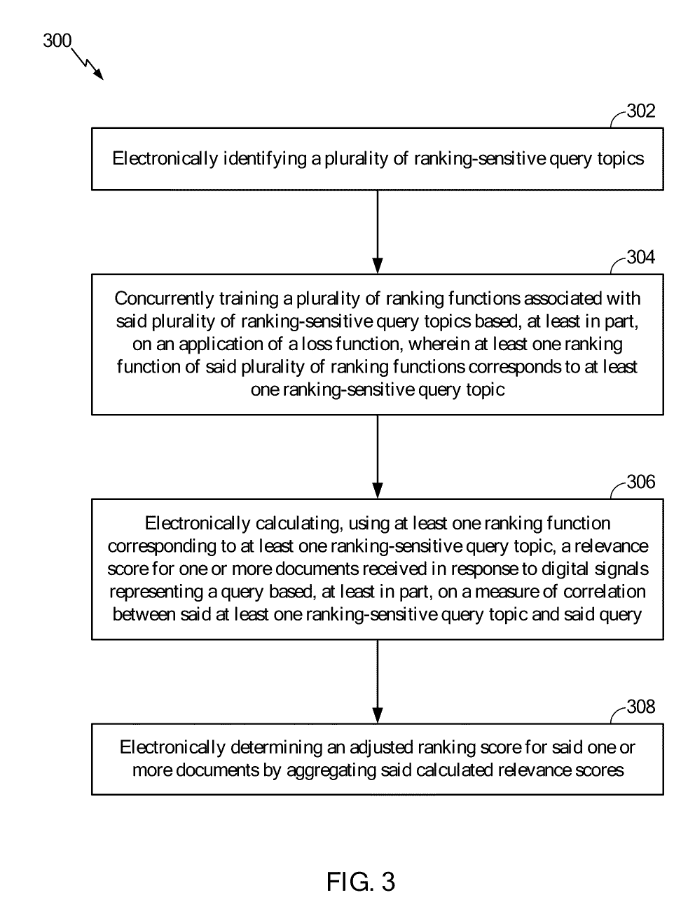

FIG. 3 is a flow diagram illustrating an example process 300 for performing ranking specialization that may be implemented, partially, dominantly, or substantially, in the context of information searches, on-line or off-line simulations, modeling, experiments, or the like. At operation 302, a plurality of ranking-sensitive query topics represented by one or more digital signals may be identified based, at least in part, on one or more pseudo-feedbacks received in response to one or more digital signals representing one or more training queries, for example. A ranking-sensitive query topic may comprise a cluster of queries, for example, that may share similar features or characteristics that may be useful or desirable for measuring ranking relevance, as was previously mentioned. With regard to operation 304, having identified ranking-sensitive query topics, a plurality of ranking functions or operations of respective ranking-sensitive query topics may be concurrently trained utilizing, at least in part, a unified SVM-based approach by defining and applying a loss function, such as, for example, a global loss function. At operation 306, a process or system may receive one or more digital signals representing one or more ranking function-calculated relevance scores for one or more documents. Suitable ranking functions may be selected, for example, based, at least in part, on a measure of correlation between corresponding ranking-sensitive query topics and a query. In one particular implementation, a measure of correlation may comprise a statistical probability of a query belonging to one or more ranking-sensitive query topics. With regard to operation 308, a process or system may organize digital signals representing one or more ranking function-calculated relevance scores for one or more documents in some manner to arrive at an adjusted ranking score. For example, an adjusted ranking score may be determined by aggregating relevance scores calculated by selected ranking functions or operations with respect to a document with weights based, at least in part, on probability of a query belonging to one or more query topics. In addition, a process or system may transmit one or more digital signals representing a listing of search results ranked, for example, in accordance with adjusted relevance scores via an electronic communications network to a special purpose computing apparatus, for example.

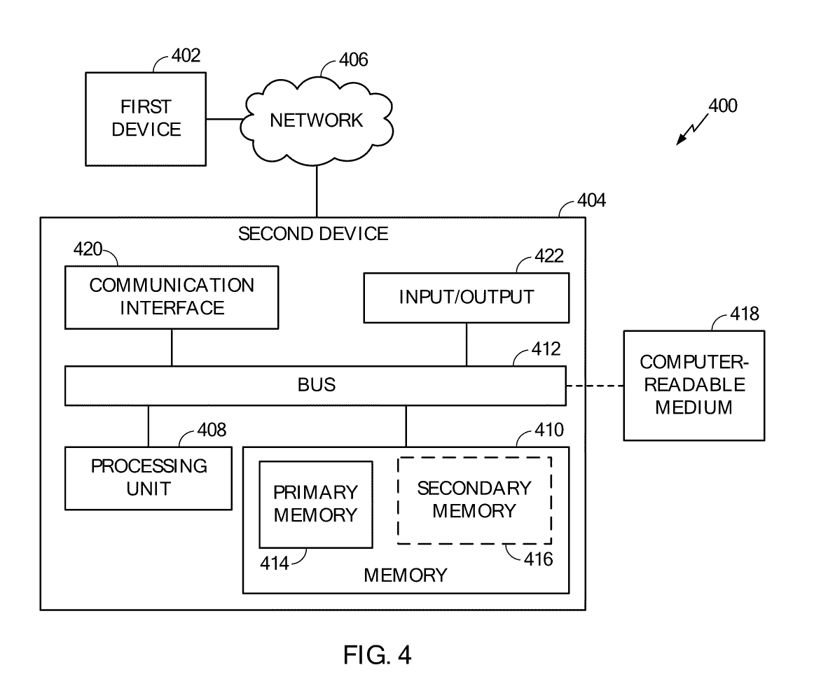

FIG. 4 is a schematic diagram illustrating an example computing environment 400 that may include one or more devices that may be configurable to partially or substantially implement a process for performing ranking specialization, partially or substantially, in the context of a search, on-line or off-line simulation, modeling, experiments, or the like.

Computing environment system 400 may include, for example, a first device 402 and a second device 404, which may be operatively coupled together via a network 406. In an embodiment, first device 402 and second device 404 may be representative of any electronic device, appliance, or machine that may have capability to exchange information over network 406. Network 406 may represent one or more communication links, processes, or resources having capability to support exchange or communication of information between first device 402 and second device 404. Second device 404 may include at least one processing unit 408 that may be operatively coupled to a memory 410 through a bus 412. Processing unit 408 may represent one or more circuits to perform at least a portion of one or more information computing procedures or processes.

Memory 410 may represent any data storage mechanism. For example, memory 410 may include a primary memory 414 and a secondary memory 416. Primary memory 414 may include, for example, a random access memory, read only memory, etc. In certain implementations, secondary memory 416 may be operatively receptive of, or otherwise have capability to be coupled to, a computer-readable medium 418. Computer-readable medium 418 may include, for example, any medium that can store or provide access to information, code or instructions for one or more devices in system 400.

Second device 404 may include, for example, a communication adapter or interface 420 that may provide for or otherwise support communicative coupling of second device 404 to a network 406. Second device 404 may include, for example, an input/output device 422. Input/output device 422 may represent one or more devices or features that may be able to accept or otherwise input human or machine instructions, or one or more devices or features that may be able to deliver or otherwise output human or machine instructions.

According to an implementation, one or more portions of an apparatus, such as second device 404, for example, may store one or more binary digital electronic signals representative of information expressed as a particular state of a device, for example, second device 404. For example, an electrical binary digital signal representative of information may be “stored” in a portion of memory 410 by affecting or changing a state of particular memory locations, for example, to represent information as binary digital electronic signals in the form of ones or zeros. As such, in a particular implementation of an apparatus, such a change of state of a portion of a memory within a device, such a state of particular memory locations, for example, to store a binary digital electronic signal representative of information constitutes a transformation of a physical thing, for example, memory device 410, to a different state or thing.

Thus, as illustrated in various example implementations and/or techniques presented herein, in accordance with certain aspects, a method may be provided for use as part of a special purpose computing device and/or other like machine that accesses digital signals from memory and processes such digital signals to establish transformed digital signals which may be stored in memory as part of one or more information files and/or a database specifying and/or otherwise associated with an index.

Some portions of the detailed description herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels.

Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described and shown herein using various methods or systems, it should be understood by those skilled in the art that various other modifications may be made, or equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
electronically identifying a plurality of ranking-sensitive query topics; and
concurrently training a plurality of ranking functions associated with said plurality of ranking-sensitive query topics based, at least in part, on an application of a loss function, wherein at least one ranking function of said plurality of ranking functions corresponds to at least one ranking-sensitive query topic.

2. The method of claim 1, wherein said electronically identifying said plurality of ranking-sensitive query topics comprises:
electronically generating one or more query features based, at least in part, on ranking features received in response to one or more digital signals representing training queries, wherein said ranking features comprise one or more feature vectors associated with said one or more training queries; and
establishing one or more clusters representative of said plurality of ranking-sensitive query topics based, at least in part, on one or more machine-learned functions.

3. The method of claim 2, wherein said one or more machine-learned functions operates in an unsupervised mode.

4. The method of claim 3, wherein said one or more machine-learned functions operating in said unsupervised mode identifies one or more digital signals representing a vector distance of said one or more feature vectors.

5. The method of claim 4, wherein said vector distance of said one or more feature vectors is determined based, at least in part, on at least one of the following: a Pearson correlation; or a weighted Pearson correlation.

6. The method of claim 1, wherein said loss function comprises a global loss function determined substantially in accordance with at least one linear function.

7. The method of claim 6, wherein said at least one linear function comprises a Topical Ranking Support Vector Machine (SVM) function.

8. A method comprising:
electronically calculating, using at least one ranking function corresponding to at least one ranking-sensitive query topic, a relevance score for one or more documents received in response to digital signals representing a query based, at least in part, on a measure of correlation between said at least one ranking-sensitive query topic and said query.

9. The method of claim 8, wherein said measure of correlation comprises a statistical probability of said query belonging to said at least one ranking-sensitive query topic.

10. The method of claim 8, and further comprising:
electronically determining an adjusted ranking score for said one or more documents by aggregating said calculated relevance scores.

11. The method of claim 10, wherein said aggregating said calculated relevance scores is based, at least in part, on a weighted sum of said relevance scores.

12. The method of claim 11, wherein said weighted sum of said relevance scores is estimated based, at least in part, on a statistical probability of said query belonging to said at least one ranking-sensitive query topic.

13. An article comprising:
a storage medium having instructions stored thereon executable by a special purpose computing platform to:
electronically identify a plurality of ranking-sensitive query topics; and
concurrently train a plurality of ranking functions associated with said plurality of ranking-sensitive query topics based, at least in part, on an application of a loss function, wherein at least one ranking function of said plurality of ranking functions corresponds to at least one ranking-sensitive query topic.

14. The article of claim 13, wherein said storage medium further includes instructions to:
electronically generate one or more query features based, at least in part, on ranking features received in response to one or more digital signals representing training queries, wherein said ranking features comprise one or more feature vectors associated with said one or more training queries; and
establish one or more clusters representative of said plurality of ranking-sensitive query topics based, at least in part, on one or more machine-learned functions.

15. An article comprising:
a storage medium having instructions stored thereon executable by a special purpose computing platform to:
electronically calculate, using at least one ranking function corresponding to at least one ranking-sensitive query topic, a relevance score for one or more documents received in response to digital signals representing a query based, at least in part, on a measure of correlation between said at least one ranking-sensitive query topic and said query.

16. The article of claim 15, wherein said storage medium further includes instructions to electronically determining an adjusted ranking score for said one or more documents by aggregating said calculated relevance scores.

17. The article of claim 15, wherein said measure of correlation comprises a statistical probability of said query belonging to said at least one ranking-sensitive query topic.

18. An apparatus comprising:
a computing platform enabled to:
electronically identify a plurality of ranking-sensitive query topics; and
concurrently train a plurality of ranking functions associated with said plurality of ranking-sensitive query topics based, at least in part, on an application of a loss function, wherein at least one ranking function of said plurality of ranking functions corresponds to at least one ranking-sensitive query topic.

19. The apparatus of claim 18, wherein said computing platform being enabled to said electronically identify a plurality of ranking-sensitive query topics is enabled to:
electronically generate one or more query features based, at least in part, on ranking features received in response to one or more digital signals representing training queries, wherein said ranking features comprise one or more feature vectors associated with said one or more training queries; and
establish one or more clusters representative of said plurality of ranking-sensitive query topics based, at least in part, on one or more machine-learned functions.

20. The apparatus of claim 18, wherein said computing platform is further enabled to electronically calculate, using at least one of said plurality of said trained ranking functions, a relevance score for one or more documents received in response to digital signals representing a query based, at least in part, on a measure of correlation between one or more of said plurality of ranking-sensitive query topics and said query, wherein said measure of correlation comprises a statistical probability of said query belonging to said one or more of said plurality of ranking-sensitive query topics.
